(19) United States
(12) Patent Application Publication
(10) Pub. No.: US 2013/0128608 A1
(43) Pub. Date: May 23, 2013

(54) LED LIGHT FIXTURE

(71) Applicants: CHIH-MING LIAO, TAOYUAN (TW); CHIH- SUNG CHEN, New Taipei City (TW); CHI-FU CHUANG, NEW TAIPEI CITY (TW)

(72) Inventors: CHIH-MING LIAO, TAOYUAN (TW); CHIH- SUNG CHEN, New Taipei City (TW); CHI-FU CHUANG, NEW TAIPEI CITY (TW)

(73) Assignee: ENLIGHT CORPORATION, TAOYUAN (TW)

(21) Appl. No.: 13/369,353

(22) Filed: Feb. 9, 2012

(30) Foreign Application Priority Data
Nov. 23, 2011 (TW) 100222137

(51) Int. Cl. F21V 11/00; F21V 8/00

(52) U.S. Cl. 362/606; 362/612

(57) ABSTRACT

The instant disclosure relates to a LED light fixture, which includes a mounting seat, a lighting module, a light guiding assembly, a retainer, and a panel. The mounting seat has a base and an annular side wall cooperatively defining a recess. The lighting module abuts the side wall and is disposed around the light guiding assembly. The retainer abuts the light guiding assembly and retains the light guiding assembly on the mounting seat. The panel is disposed between the light guiding assembly and the base, with the periphery of the panel abutting the engaging shafts. Thereby, the interaction between the retainer and the mounting seat enables the user to assemble or dismantle the light fixture with more ease.

### BACKGROUND OF THE INVENTION

1. Field of the Invention

The instant disclosure relates to a light fixture; in particular, to a light fixture utilizing a LED as the light source.

2. Description of Related Art

Conventionally, light fixtures utilize tungsten light bulbs or mercury-vapor lamps as the light source. However, these light sources have high energy consumption and produce heat that raises the ambient temperature, in addition to having short service life. Whereas typical fluorescent lamps have flickering problems harmful to the eyes of the user.

Therefore, new forms of light sources are researched and developed to solve the shortcomings of the conventional light fixtures. One of the discovered light sources is light-emitting diode, also known as the LED. Theoretical reports show that the LED can operate at a very low power with a lifespan far longer than any existing light source. In addition, the exclusion of tungsten filaments and mercury-vapor enable the LEDs to be environmental friendly. Therefore, the LEDs are gradually replacing the traditional light sources.

When assembling, majority of the LED light fixtures require some type of fasteners to complete the assembling process. When the LED is to be replaced, the light fixture is to be disassembled to change out internal components. Meanwhile, structural adjustments are often made to the light fixture to improve its heat dissipating efficiency. However, more improvements can be made to provide the user with greater convenience in assembling/disassembling the light fixture.

To address the above issues, the inventors strive via industrial experience and academic research to present the instant disclosure, which can effectively improve the limitations described above.

### SUMMARY OF THE INVENTION

The object of the instant disclosure is to provide a LED light fixture having a retainer latched to a mounting seat, to provide easy assembling and dismantling of the LED light fixture.

To achieve the aforementioned object, the LED light fixture provided by the instant disclosure includes a mounting seat, a lighting module, a light guiding assembly, a retainer, and a panel. The mounting seat has a base and an annular side wall extending therefrom. The base and the side wall cooperatively define a recess. The lighting module includes a plurality of light-emitting units and an annular holder for retaining the light-emitting units. The lighting module is disposed in the recess and abuts the side wall. The light guiding assembly is also disposed in the recess and surrounded by the lighting module. The retainer has a connecting ring and a plurality of engaging shafts extending therefrom. The light guiding assembly is retained to the mounting seat by being abutted by the retainer. The engaging shafts abut expansively against the lighting module. The panel is arranged between the light guiding assembly and the base, where the periphery of the panel abuts the engaging shafts.

Based on the above, for the LED light fixture provided by the instant disclosure, the recess is concavely formed mounting seat. The lighting module, the light guiding assembly, and the panel are received by the recess. The lighting module abuts the side wall and loops around the light guiding assembly. The retainer abuts the light guiding assembly, and the periphery of the panel abuts the engaging shafts. Thus, when the light fixture is assembled, the retainer allows the lighting module, the light guiding assembly, and other components to be removably secured to the mounting seat. Hence, the user can easily assemble or dismantle the LED light fixture.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows an exploded view of a LED light fixture according to the instant disclosure;

FIG. 2 shows another exploded view of the LED light fixture, viewing from another angle, according to the instant disclosure;

FIG. 3 shows an assembled view of the LED light fixture according to the instant disclosure;

FIG. 4 shows another assembled view of the LED light fixture, viewing from another angle, according to the instant disclosure;

FIG. 5 shows a cross-sectional view of the LED light fixture according to the instant disclosure;

FIG. 6 shows another cross-sectional view of the LED light fixture according to the instant disclosure;

FIG. 6A shows a partial enlarged view of FIG. 6 according to the instant disclosure.

### DETAILED DESCRIPTION OF THE PREFERRED EMBODIMENT

Unless stated otherwise, all mentioned quantities are not intended to be limiting.

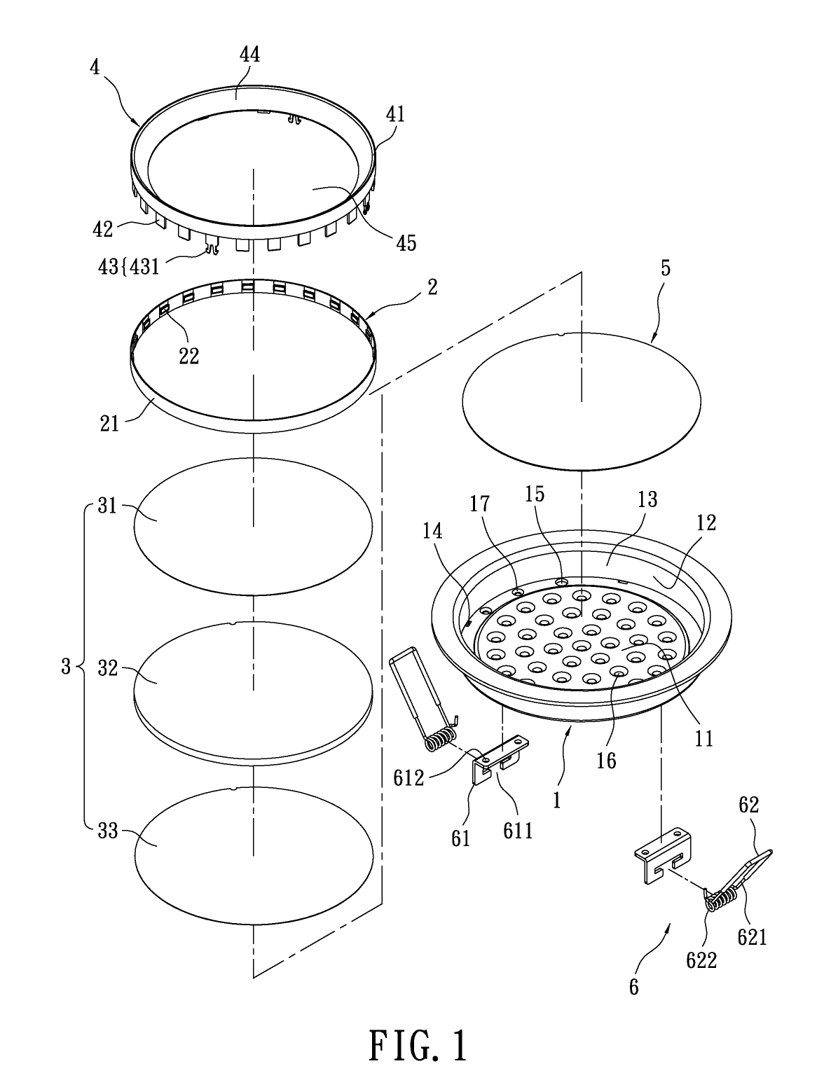

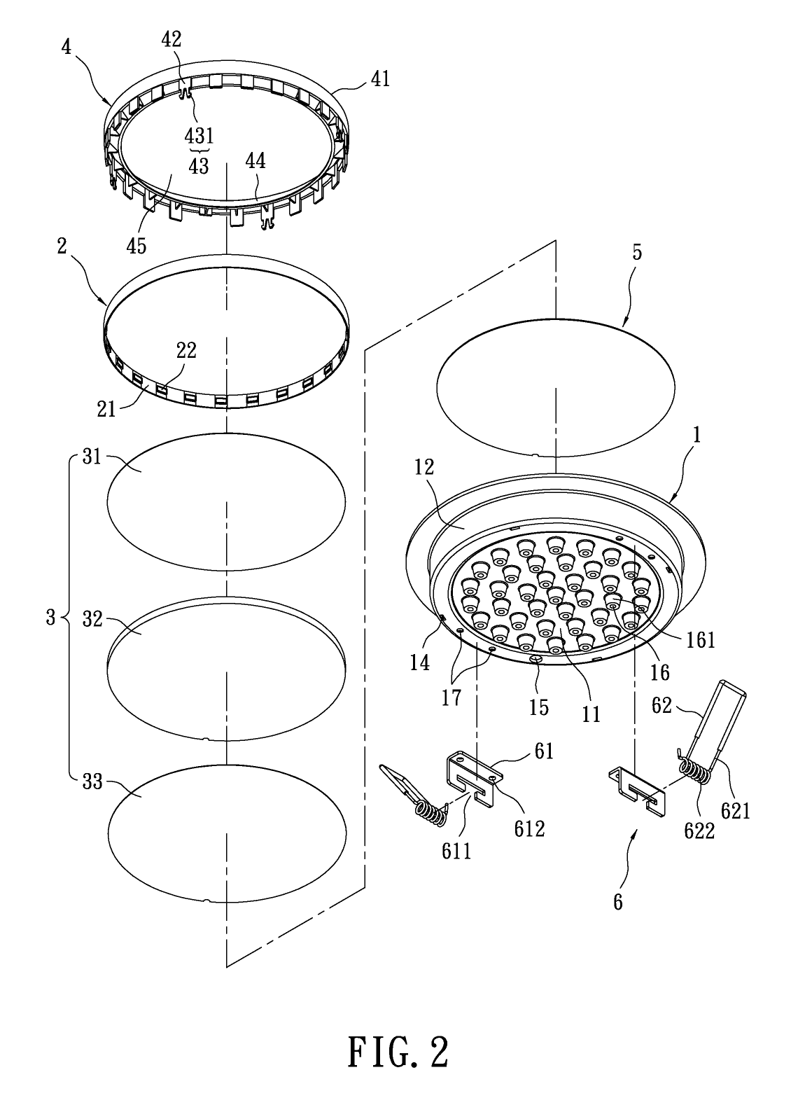

Please refer to FIGS. 1-2, which show a LED light fixture in accordance to an embodiment of the instant disclosure. This light fixture is particularly suitable for illuminating devices that emit light laterally. The light fixture includes a mounting seat 1, a lighting module 2, a light guiding assembly 3, a retainer 4, a panel 5, and two mounting elements 6.

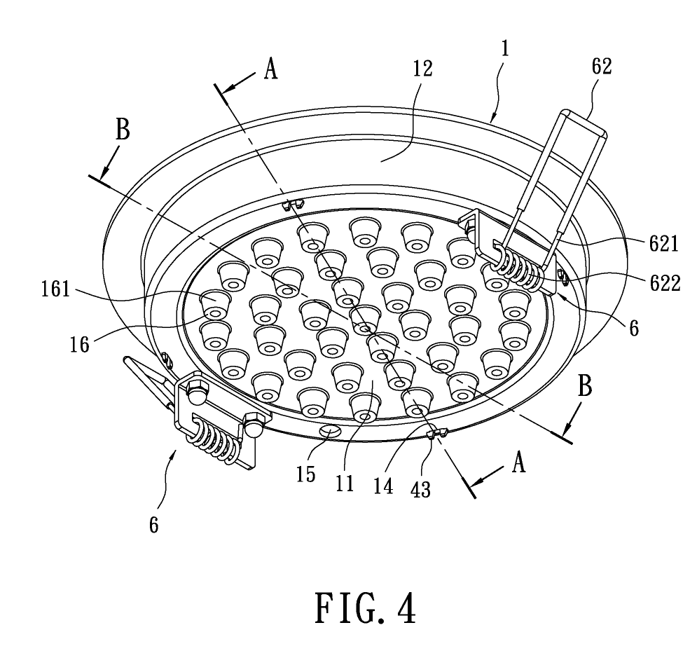

Please refer to FIGS. 2 and 4, where the mounting seat 1 has a base 11 and an annular side wall 12. The base 11 has a heat dissipating portion 16. There are four retaining holes 14, a cable hole 15, and four mounting holes 17 formed on the base 11.

The side wall 12 extends normally from the base 11, where the base 11 and the side wall 12 cooperatively form a recess 13 (as shown in FIG. 1). The side wall 12 is preferably circular shaped, however, the side wall 12 may also be rectangular shaped or being polygonal without shape restriction. The heat dissipating portion 16 is defined by a plurality of tubular protrusions 161 extending outwardly from the base 11. The purpose of these protrusions 161 is to increase the heat dissipating efficiency of the light fixture. Additionally, the retaining holes 14 and mounting holes 17 are formed annularly on the periphery of the base 11.

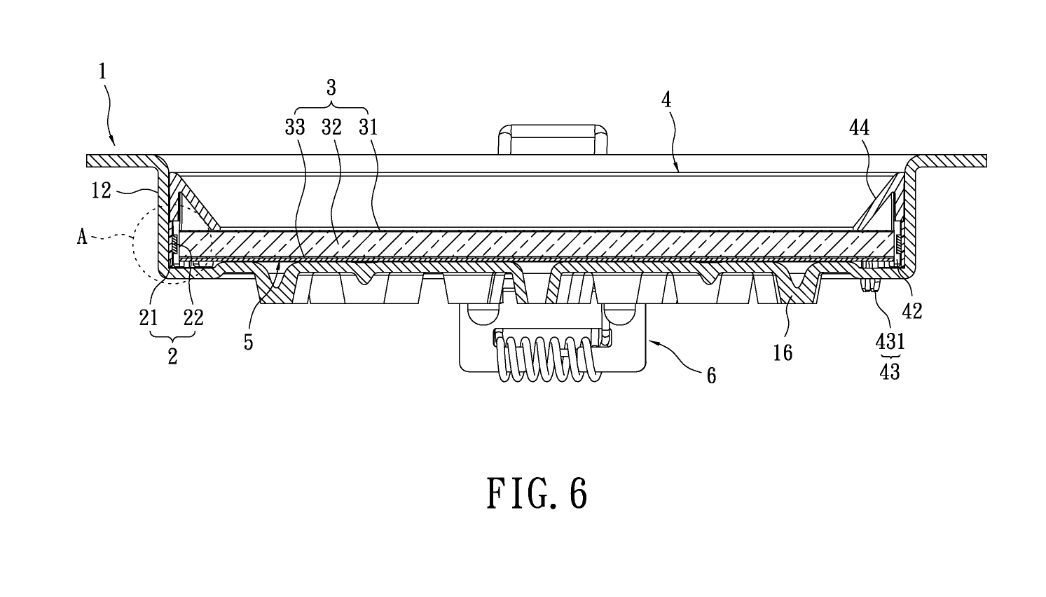

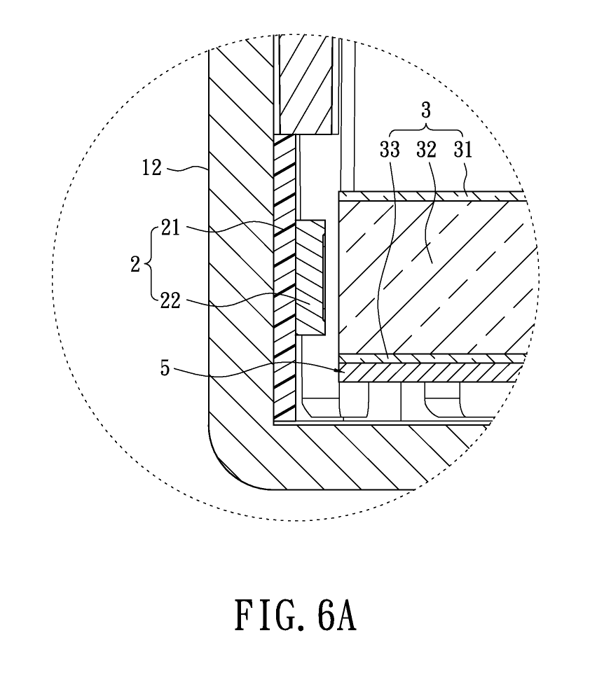

Please refer to FIGS. 1 and 6. The lighting module 2 has an annular holder 21 and a plurality of light-emitting units 22. The light-emitting units 22 may be glued to the holder 21, and the holder 21 abuts the side wall 12. The above structural descriptions are for a preferred embodiment, however, in practice, the actual structural arrangement is not restricted thereto.

Please refer to FIGS. 1 and 6A. The light guiding assembly 3 includes a diffuser 31, a light guiding member 32, and a reflector 33. All three components are disc-shaped for the instant embodiment. The reflector 33, the light guiding member 32, and the diffuser 31 are sequentially disposed in the recess 13. The lighting module 2 is arranged between the light guiding assembly 3 and the side wall 12. Light from the light-emitting units 22 is emitted into the light guiding member 32 (as shown in FIG. 6). Please note, the light guiding member 32 preferably has a plurality of micro diffusers. However, other types of light guiding members may be used to provide different light guiding effects.

Please refer back to FIGS. 1 and 2. The retainer 4 is circular shaped having a connecting ring 41 and a plurality of engaging shafts 42.

The connecting ring 41 has a tapered blocking portion 44 defined by a central opening 45. The blocking portion 44 is substantially a funnel-like structure which secures the light guiding assembly 3 by abutting thereto. The opening 45 is formed in correspondence to the light guiding assembly 3 and is in communication with the recess 13. A portion of the light guiding assembly 3 is exposed through the opening 45. The light emitting from the lighting module 2 is reflected or refracted by the light guiding assembly 3, before exiting the light fixture through the opening 45.

The engaging shafts 42 extend from a side portion of the connecting ring 41. For the instant embodiment, each of the four engaging shafts 42 has a restricting member 43 in correspondence to the retaining holes 14. Each of the restricting members 43 has a pair of hooks 431 extending in opposite direction from a distal end thereof. Thereby, the hooks 431 pass through the retaining holes 14 and latch to the outer surface of the base.

Each of the engaging shafts 42 is an elongated deflectable strip abutting to the holder 21. In other words, the area enclosed by the engaging shafts 42 is slightly greater than the area enclosed by the holder 21. Therefore, when the engaging shafts 42 are disposed in the recess 13, the inherent deflecting nature allows the engaging shafts 42 to abut expansively to the holder 21. Thereby, the retainer 4 can be fixedly attached to the mounting seat 1. To dismantle the light fixture, the user simply needs to disengage the engaging shafts 42 from the retaining holes 14 to change out the internal components (e.g., the lighting module 2). Such design greatly simplifies the disassembling process of the light fixture.

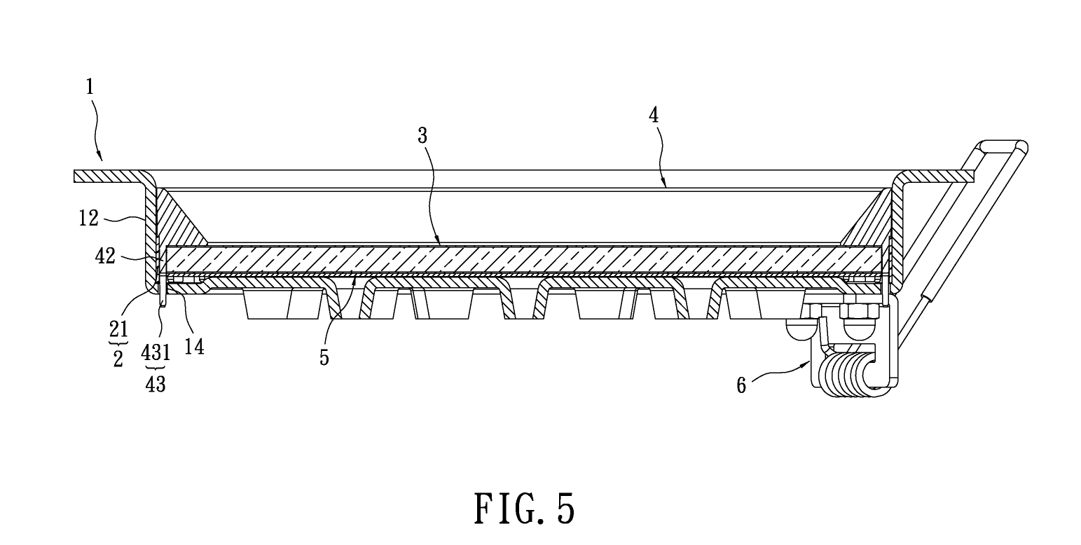

Please refer to FIGS. 1 and 5. The instant embodiment further includes a rigid disc-shaped panel 5. The panel 5 is preferably made of a light-obstructing iron material, but is not restricted thereto. The panel 5 is sandwiched between the light guiding assembly 3 and the inner surface of the base 11 inside the recess 13. The periphery of the panel 5 abuts to the engaging shafts 42. Thus, even when the engaging shafts 42 expand or contract due to extreme temperatures, the panel 5 ensures the engaging shafts 42 remain abutting to the holder 21. Consequently, the holder 21 can remain in contact with the side wall 12 to maintain adequate heat dissipation for the light fixture.

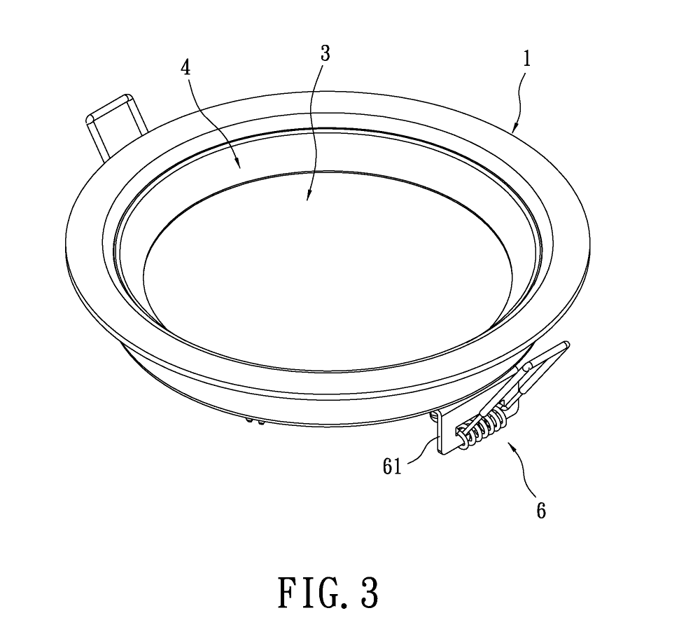

Please refer to FIGS. 2 and 3. The instant embodiment further includes two mounting elements 6. Each of the mounting elements 6 includes an L-bracket 61 and a handle 62. The L-bracket 61 has a pair of through holes 612 formed thereon in correspondence to the mounting holes 17 and has a notch 611. The handle 62 has a connecting end 621 and a screw-like elastic member 622 extending therefrom. The opposite ends of the elastic member 622 are held in the notch 611 of the L-bracket 61. The mounting elements 6 are arranged on the outer surface of the base 11, where screws/bolts are driven through the through holes 612 and mounting holes 17. However, other types of fastening means may be employed to achieve the same effect.

For the instant embodiment, a driving circuit (not shown) is further provided. The driving circuit may be secured by the mounting elements 6, where the cable(s) (not shown) of the lighting module 2 passes through the cable hole 15 to connect electrically to the driving circuit.

From the foregoing, for the LED light fixture provided by the instant disclosure, the base and the side wall cooperatively form the recess. The lighting module abuts the side wall enables adequate heat dissipation for the light fixture. The lighting module is disposed around the light guiding assembly. The retainer abuts and secures the light guiding assembly to the mounting seat, where the restricting members of the engaging shafts latch to the mounting seat to provide structural stability. The periphery of the panel abuts the engaging shafts of the retainer to prevent any component of the light fixture from loosening due to thermal expansion or contraction. Additionally, the heat dissipating portion of the base has a heat dissipating surface capable of enhancing the heat dissipation efficiency.

The descriptions illustrated supra set forth simply the preferred embodiment of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A LED light fixture, comprising:
a mounting seat having a base and an annular side wall extending therefrom, wherein the base and the side wall cooperatively form a recess;
a lighting module having a plurality of light-emitting units and an annular holder for retaining the light-emitting units, wherein the lighting module is disposed in the recess and abuts the side wall;
a light guiding assembly disposed in the recess and surrounded peripherally by the lighting module;
a retainer having a connecting ring and a plurality of engaging shafts extending therefrom, wherein the retainer abuts the light guiding assembly for retaining the light guiding assembly to the mounting seat, while the engaging shafts abut the lighting module; and
a panel arranged between the light guiding assembly and the base, wherein the periphery of the panel abuts the engaging shafts.

2. The LED light fixture according to claim 1, wherein at least one retaining hole and at least one cable hole are formed on the base.

3. The LED light fixture according to claim 1, wherein the holder abuts the side wall.

4. The LED light fixture according to claim 2, wherein the engaging shafts are deflectable strips, wherein at least one of the engaging shafts has a restricting member passed through the retaining hole for latching to the base.

5. The LED light fixture according to claim 1, wherein the retainer is annular shaped having a tapered blocking portion for abutting the light guiding assembly and is defined by a central opening for exposing a portion of the light guiding assembly.

6. The LED light fixture according to claim 1, wherein each light-emitting unit is arranged between two adjacent engaging shafts.

7. The LED light fixture according to claim 1, wherein the light guiding assembly includes a reflector, a light guiding member, and a diffuser sequentially disposed in the recess, wherein the retainer abuts the diffuser.

8. The LED light fixture according to claim 1, wherein the mounting seat has a heat dissipating portion formed on the base.

9. The LED light fixture according to claim 8, wherein the heat dissipating portion has a plurality of tubular protrusions extending from the base.

10. The LED light fixture according to claim 1, further comprising at least one mounting element attached to the base of the mounting seat.
